(19) United States
(12) Patent Application Publication
(10) Pub. No.: US 2024/0396376 A1
(43) Pub. Date: Nov. 28, 2024

(54) WIRELESS CHARGING STATION THAT ADJUSTS OUTPUT POWER BASED ON DISTANCE TO A USER

(71) Applicant: INTERNATIONAL BUSINESS MACHINES CORPORATION, Armonk, NY (US)

(72) Inventors: SU LIU, AUSTIN, TX (US); CHRISTOPHER S. HERMOSILLO, PHOENIX, AZ (US); SYED I. HAIDERZAIDI, AUSTIN, TX (US); JAMES NASH, COPPELL, TX (US)

(21) Appl. No.: 18/322,199

(22) Filed: May 23, 2023

(51) Int. Cl. H02J 50/60; H02J 50/80

(52) U.S. Cl. CPC H02J 50/60; H02J 50/80; H02J 50/10; H02J 50/20

(57) ABSTRACT

A wireless charging station includes a power transmitting antenna; a controller, a distance-to-user tool of the controller to determine a distance between a user and the wireless charging station; and an output power control of the controller to adjust a power output of the power transmitting antenna based on the determined distance between the user and the wireless charging station.

### BACKGROUND

Wireless power charging is used to deliver energy to power-consuming devices without a physical connection and is very convenient for the consumer. Typically, the amount of power transmitted is a fixed amount set by the transmitter. However, this can lead to an inefficiency if the amount of power is more than is needed, resulting in wasted or unconsumed wireless energy. On the other hand, delivering too little energy may not effectively charge the power-consuming device. Delivering energy at a time when it will not be consumed also results in waste. While wireless power charging has many great applications, there is ongoing debate and research regarding the potential health risks associated with exposure to electromagnetic fields (EMFs) emitted by wireless chargers.

According to the National Institute of Environmental Health Sciences, “[w] ireless charging devices emit non-ionizing radiation that can penetrate human tissue. However, the intensity of this radiation is generally considered to be low and unlikely to cause harm” (“Electric and Magnetic Fields.” National Institute of Environmental Health Sciences, n.d., https://www.nichs.nih.gov/health/topics/agents/emf/index.cfm.). Despite this, some studies have suggested that exposure to electromagnetic fields (EMFs) from wireless chargers may increase the risk of certain health problems, including cancer, neurological disorders, and reproductive issues (Soffritti, Morando, et al. “Scientific challenges in the risk assessment of modern wireless telecommunications.” Journal of Environmental Research and Public Health, vol. 13, no. 5, 2016, p. 541, doi: 10.3390/ijerph13050541.). The World Health Organization (WHO) has also expressed concern about EMFs, classifying electromagnetic radiation as “possibly carcinogenic to humans” based on some evidence of a link between long-term exposure to high levels of EMFs and an increased risk of certain types of cancer “Electromagnetic Fields and Public Health: Mobile Phones.” World Health Organization, 2011, https://www.who.int/news-room/q-a-detail/electromagnetic-fields-and-public-health-mobile-phones.).

The Biolnitiative Group issued a 2012 report, written by a group of independent scientists and health experts from around the world, that has recently been updated in 2017. According to the updated reported, studies are beginning to confirm the concerns mentioned above with regard to exposure to EMFs. (BioInitiative Report. “Conclusions.” BioInitiative, 2012, https://bioinitiative.org/conclusions/). The research presented in the updated report warns that, “[b] ioeffects are clearly established and occur at very low levels of exposure to electromagnetic fields and radiofrequency radiation.” (Id.). The evidence for the bioeffects in question suggests the effects of EMFs can be genetic, neurological, increase risk of childhood cancers, decrease melatonin production. (Id.).

Thus, while some studies have suggested that exposure to EMFs may have harmful effects on human health, the research is ongoing and is needed to fully understand the potential risks. In the meantime, it is recommended to limit exposure to EMFs by using electronic devices as directed, keeping them away from the body, and avoiding prolonged exposure.

### SUMMARY

According to an example of the present subject matter, a wireless charging station includes a power transmitting antenna; a controller; a distance-to-user tool of the controller to determine a distance between a user and the wireless charging station; and an output power control of the controller to adjust a power output of the power transmitting antenna based on the determined distance between the user and the wireless charging station.

In another example of the present subject matter, a method of operating a wireless charging station includes: detecting presence of a user in proximity to the wireless charging station; determining a distance between the user in proximity to the wireless charging station and the wireless charging station; and adjusting an output power of an antenna of the wireless charging station based on the distance between the user and the wireless charging station so as to reduce exposure of the user to an electro-magnetic field of the wireless charging station.

In another example of the present subject matter, a computer program product includes a non-transitory computer-readable medium storing instructions for a controller of a wireless charging station. The instructions, when implemented by a processor of the controller, cause the controller to: detect a presence of a user in proximity to the wireless charging station; determine a distance between the user in proximity to the wireless charging station and the wireless charging station; and adjust an output power of an antenna of the wireless charging station based on the distance between the user and the wireless charging station so as to reduce exposure of the user to an electro-magnetic field of the wireless charging station.

### BRIEF DESCRIPTION OF THE DRAWINGS

The drawing and figures depict examples of the subject matter described in the present specification. These illustrations are by way of example only, not by way of limitation to the appended claims. In the figures, like reference numerals refer to the same or similar elements. It should also be understood that the drawings are not necessarily to scale.

FIG. 1 depicts a computing environment for the execution of a computer-implemented method or application, according to an example of the principles described herein.

FIG. 2 depicts an example of a wireless charging station and surrounding environment according to the principles described herein.

FIG. 3 depicts another example of a wireless charging station and surrounding environment according to the principles described herein.

FIG. 4. depicts the safety distance ranges implemented by the wireless charging station described herein.

FIG. 5 depicts components of an illustrative wireless charging system according to the principles described herein.

FIG. 6 depicts a flowchart of an illustrative wireless charging system according to the principles described herein.

FIG. 7 depicts different output power settings of an illustrative wireless charging system according to the principles described herein.

FIG. 8 depicts use of an illustrative wireless charging system in a particular conference room environment according to the principles described herein.

FIG. 9 depicts use of an illustrative wireless charging system in an electric vehicle charging application according to the principles described herein.

FIG. 10 depicts a flowchart of operation of an illustrative wireless charging system according to the principles described herein.

FIG. 11 depicts a non-transitory computer-readable medium with programming for a controller of an illustrative wireless charging system according to the principles described herein.

### DETAILED DESCRIPTION

As noted above, wireless power charging is used to deliver energy to power-consuming devices without a physical connection and is very convenient for the consumer. Wireless charging devices are used to charge a variety of devices from mobile phones to electric vehicles.

However, wireless power charging can expose nearby users to EMFs and, as noted above, there may be health concerns associated with this exposure. Recent measurements of common wireless chargers demonstrate EMFs of greater than 100 mG. One current recommendation based on health concerns is to limit EMF exposure to ImG. Consequently, common wireless charging devices may be delivering over 100 times the EMF exposure recommended.

Consequently, the present specification addresses the need to limit the potentially unhealthy exposure to EMFs created by wireless charging points or stations that users experience. In particular, this is done by detecting the proximity of users to the wireless charging device and reducing the output power and EMF of the wireless charging device while a user is within a certain distance. This approach may also intelligently classify different types of users, such as children and pregnant women, who may need even more protection from exposure to EMFs.

As used herein and in the appended claims, the terms “wireless charging device” or any variation thereof refers to contact and Near-Field Communication (NFC) charging devices as well as longer distance charging devices. Radio Frequency (RF) based charging may allow for devices to be charged anywhere in the same room or similar vicinity of a charger. Some such units are currently able to send power over distances greater than 15 feet. In the United States, the Federal Communications Commission (FCC) limits the maximum power output of an RF power transmitter to just one watt. Adaptive charging refers to a methodology that uses battery data to control the output of a charger on a dynamic basis.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse or any given order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used in the present specification and in the appended claims, the term “a number of” or similar language is meant to be understood broadly as any positive number including 1 to infinity.

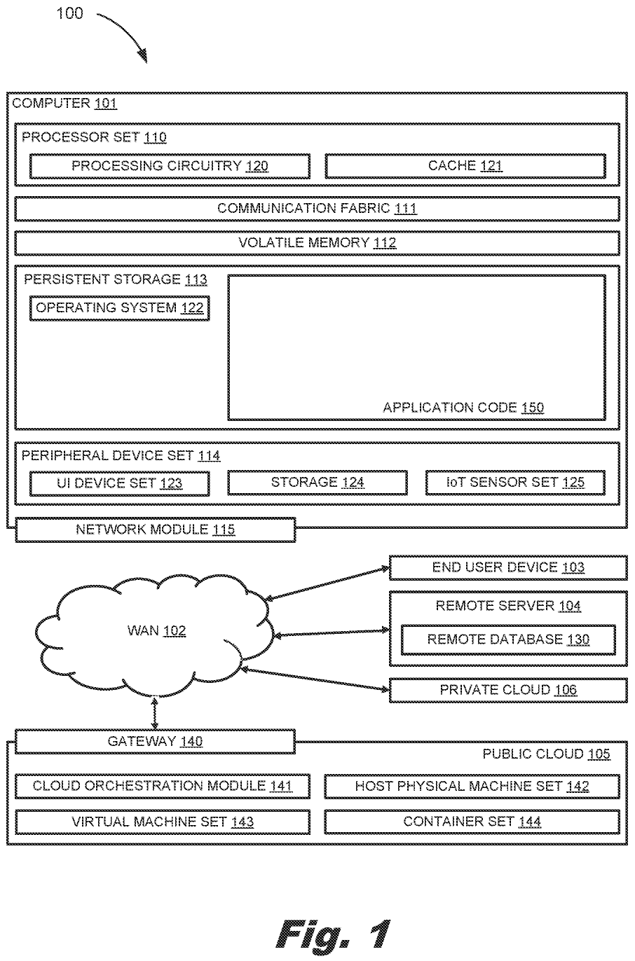

Turning now to the figures, FIG. 1 depicts a computing environment 100 for the execution of unknown object sub-class identification, according to an example of the principles described herein.

Computing environment 100 contains an example of an environment for the execution of at least some of the computer code involved in performing the inventive methods, an application to provide context specific recommendations to producers regarding the satisfaction of their users. In addition to application code block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

The EUD 103 may be a client device operated by a producer of services or products that wants an analysis of available user data to ascertain user satisfaction. Operation of the EUD 103 for this objective will be described in further detail below.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

As described further below, the EUD 103 may use the network 102 to access an application on remote server 104. The application will access, again using the network 102, available user data. The application will then analyze the user data, with context specific analysis, to ascertain user satisfaction and generate recommendations for the producer based on the analysis.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

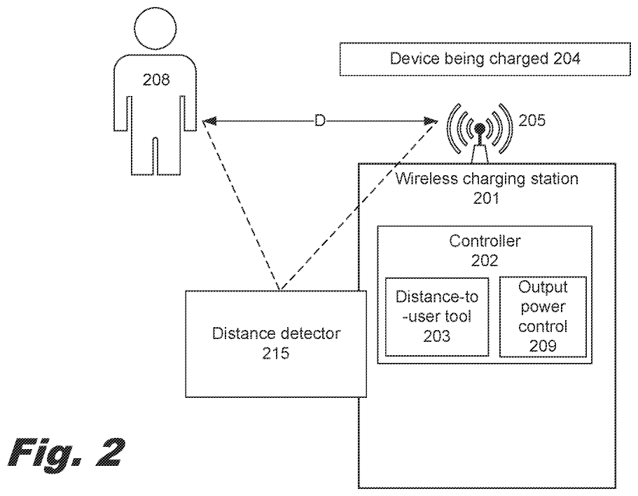

FIG. 2 depicts an example of a wireless charging station and surrounding environment according to the principles described herein. As shown in FIG. 2, a wireless charging station 201 uses a power transmitting antenna 205 to create an electromagnetic field (EMF) that charges a battery of a device 204 that is proximate to the charging station 201.

Wireless charging, also known as inductive charging, is a method of charging electronic devices without using physical cables. It uses an EMF to transfer energy between two objects, namely the charging station and the device being charged. Thus, wireless charging involves two components: a charging station 201 and a receiving device 204. The charging station is connected to a power source, such as a wall outlet, and generates an electromagnetic field. A receiver, which is embedded in the device being charged 204, contains a coil of wire that is able to pick up the electromagnetic field and convert it into electrical energy to charge the battery of the device 204. More specifically, when the receiving device is placed in proximity to the charging station 201, the electromagnetic field induces a current in the coil, which is then converted into DC power and used to charge the battery. The greater the distance between the charging station 201 and the device being charged 204, the less efficient is the transfer of power. The charging process stops once the battery is fully charged or the device is removed from the charging station vicinity.

As noted above, there may be health concerns with exposing a human user 208 to the EMF of the charging station 201. Consequently, the charging station 201 of FIG. 2 includes a controller 202 that is programmed to adjust the output power of the antenna 205 based on the proximity of the user 208. As will be described below, the charging station 201 may also consider the sensitivity of different types of user to the EMF and further adjust the output owner of the antenna 205 based on the type of user that is present.

As shown in FIG. 2, a distance detector 215 is used to determine a distance between the user 208 and the wireless charging station 201. This detector 215 could be integrated with the wireless charging station 201 or a separate component in communication with the wireless charging station 201. For example, the distance detector 215 may be a camera that images the user 208 and determines the distance D based on the imaging. In other examples, the distance detector may be a body heat sensor, a movement detector, an acoustic sensor or any other type of sensor able to determine an estimate of the distance D between the user 208 and wireless charging station 201.

The output of the distance detector 215 is provided to a distance-to-user tool 203 of the controller 202. In various example, this tool 203 uses the raw data from the distance detector 215 to determine a value for the distance D between the user 20 and the wireless charging station 201. The wireless charging station 201 also includes an output power control 209 of the controller 202. The output power control 209 will receive the value for D from the tool 203 and adjust the output power of the antenna 205 accordingly. Specifically, if the distance D is determined to be within a first range closest to the wireless charging station 201, the output power of the antenna 205 is reduced to a minimum setting. If the distance D is determined to be outside the first range but within a second, larger range, the output power of the antenna 205 may be increased to a medium setting. If the distance D is determined to be outside the second range but within a third, still larger range, the output power of the antenna 205 may be increased to a maximum setting. Any number of different ranges and intermediate power settings may be implemented in examples of the wireless charging station 201.

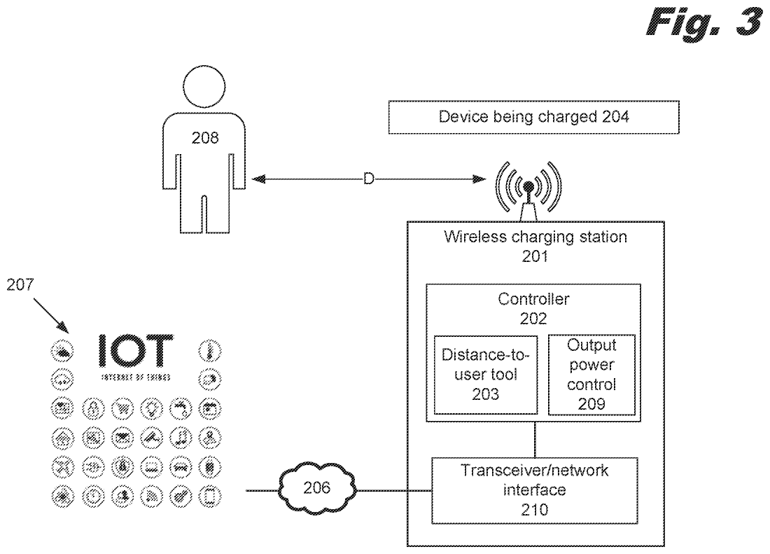

FIG. 3 depicts another example of a wireless charging station and surrounding environment according to the principles described herein. The example of FIG. 3 is similar to that of FIG. 2. However, in FIG. 3, the wireless charging station 201 includes a transceiver or network interface 210 that allows the wireless charging station 201 to communicate with devices 207 belonging to the Internet of Things (IoT) in the vicinity of the wireless charging station 201. This communication may be directed between the devices or via a network 206, such as the internet or a Local Area Network (LAN).

As used herein, the term “Internet of Things” or “IoT” refers to a network of physical objects, devices, vehicles, and other items that are embedded with sensors, software, and connectivity, allowing them to collect and exchange data with other devices and systems over the internet. The term “IoT device” refers to any such device that is part of the IoT.

The concept of IoT is based on the idea of connecting everyday objects and devices to the internet and enabling them to communicate with each other and with humans. This can include anything from smart homes and appliances, wearable devices, vehicles, industrial equipment, and more. IoT devices typically collect data from their environment, such as temperature, humidity, light, motion, and other variables, and transmit this data to other devices or systems for processing and analysis. This data can be used to automate processes, optimize operations, and provide valuable insights for businesses and individuals.

Thus, IoT devices 207 in the vicinity of the wireless charging station 201 can be used to help determine the distance D between the user 208 and the wireless charging station 201. For examples, a wearable device that the user 208 is wearing may transmit data helping define the user's location that is used by the distance-to-user tool 203. In other examples, cameras or other sensors in the IoT devices 207 can transmit data helping to establish the user's proximity to the wireless charging station 201. In other examples, microphones in the IoT devices 207 may provide data helping to locate the user 208 relative to the wireless charging station 201. Any output from an IoT device that helps locate the user may be used by the distance-to-user tool 203 of the controller 202.

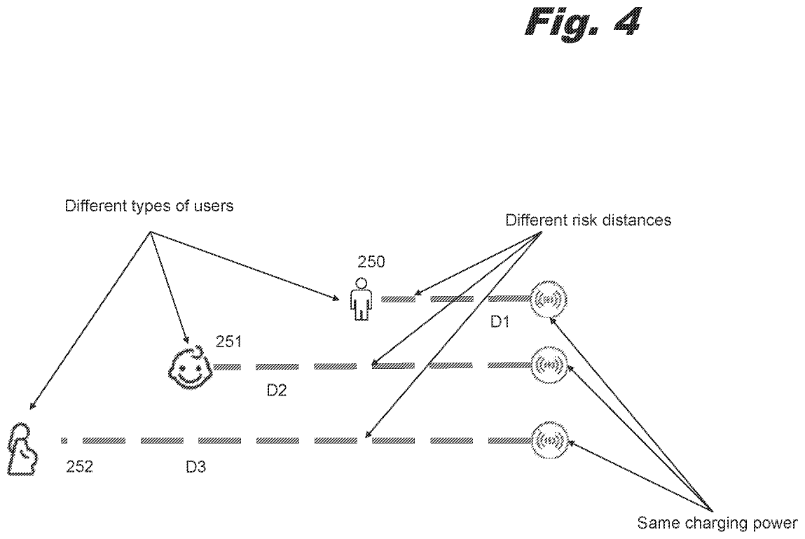

FIG. 4. depicts the safety distance ranges implemented by the wireless charging station described herein. As shown in FIG. 4, different types of users may have different sensitivities and risk factors to EMF exposure. Consequently, there may be different distances from a wireless charging station 201 that are considered recommended based on a user's type.

For example, with a wireless charging station 201 that is operating at a constant power output level, an average user 250 may have a recommended safe distance D1 from the wireless charging station 201 to limit exposure to the EMF of the station. In contrast, children 251 or younger individuals who are still developing mentally and physically may have a longer recommended safe distance D2 from the wireless charging station 201. Furthermore, a pregnant woman may have an even greater recommended safe distance D3 from the wireless charging station 201 due to the possible effects of EMFs on an unborn child.

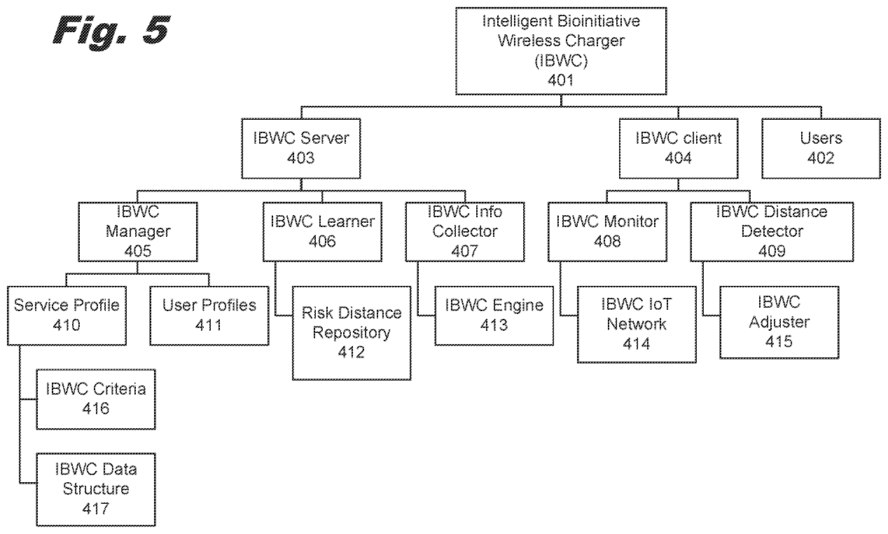

FIG. 5 depicts components of an illustrative wireless charging system according to the principles described herein. An intelligent bioinitiative wireless charger (IBWC) 401 includes the functionality described above to intelligently and automatically protect the health of human users or other biological entities from the EMFs created. As shown in FIG. 5, this system includes the wireless charger, here referred to as an IBWC client 404, and the users 402 of charger. An IBWC server 403 may communicate with the controller of the client 404 to provide additional support and functionality as will be described below.

Similar to the examples above, the IBWC client 404 includes a distance detector 409 and an adjuster 415 for adjusting the output power of the charger. A monitor 408 provides the interface with the IoT network 414 that may be providing data for detecting the presence and distance to a user, as described above.

The server 403 can provide the following services. Users or administrators are represented by the IBWC manager 405. These individuals can set user profiles 411 and service profiles 410. The user profiles 411 may define different types or classes of persons or other biological entities to be treated differently by the charger. For example, as noted above, different types or classes of person needing different layers of protection may include children, pregnant women and others. Other categories can be set in the user profiles 411. Each user profile 411 can be paired with a service profile 410 that specifies how the charger will be operated in the presence of a member of the corresponding user group. This service profile 410 may specify an output power level or criteria 416 to be considered to determine an output power level for each user profile 411. The data structure 417 may include data for tracking and saving user locations and current wireless charging power strength. A typical data structure 417 may include charging station identification, battery identification, impacted users identification, current distance estimation and other parameters.

The IBWC learner 406 may store the association between a particular user group and a recommended safe distance based on the output power of the charger. A risk distance repository 412 can store recommendations on safe distances based on user group, output power and other factors. The IBWC info collector 407 accumulates the information available on the server 403 and provides the information to the individual IBWC engine 413, e.g., a deployed charger in communication with the server 403 via a computer network.

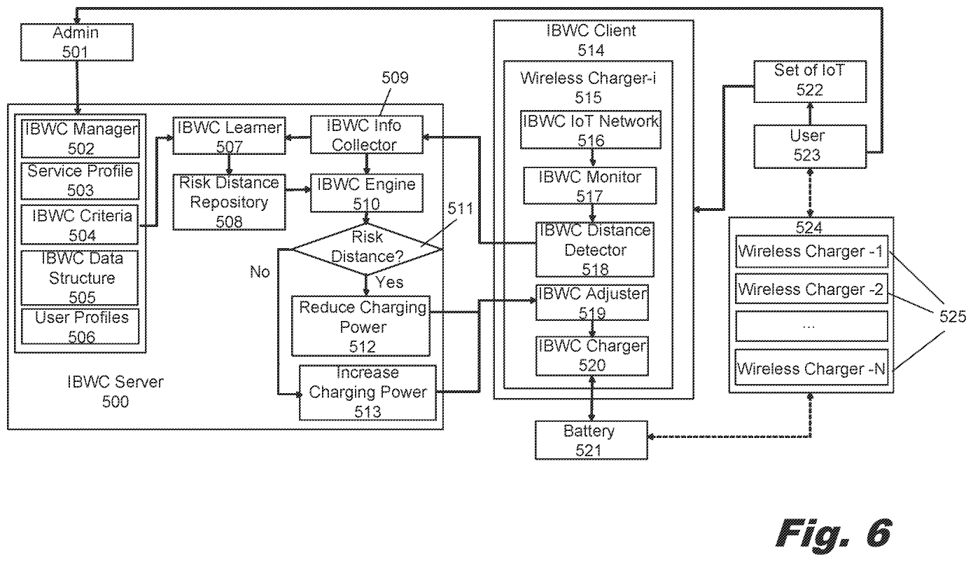

FIG. 6 depicts a flowchart of an illustrative wireless charging system according to the principles described herein. In the example of FIG. 6, the logic for determining the output power is in the server 500 and transferred to the IBWC client 514 remotely.

As shown in FIG. 6, the IBWC client 514 can be considered to include the charger environment 515, including the IoT network of devices 516 that communicate with the charger via the monitor 517. A distance detector 518 and adjuster 519 function as described above to operate the charger 520, i.e., the antenna, at a determined output power. As a result, current is provided to charge a battery 521 of a device being charged.

The user 523 can define the set of IoT devices 522 available to the client 514. The user 523 may pair or otherwise grant access between the IoT devices 522 and the client 514. The environment may include any number 524 of different charging stations 525.

On the left, the server 500 may be overseen by an administrator 501. As discussed above, with respect to FIG. 5, the server 500 includes a manager 502, service profiles 503, IBWC criteria 504, IBWC data structure 505 and user profiles 506. The criteria 504 are available to the IBWC learner 507, as is the data in the risk distance repository 508. The IBWC info collector 509 receives data from the client 514 to help the learner 507 capture data about the environment of the client, such as behavior of ther users 523. The IBWC engine 510 makes use of all the available data to determine 511 if a user is at risk due to proximity to the charger 520. If yes, an instruction 512 to reduce the charging or output power is sent to the client 514. In contrast, if there is no user at risk based on distance between the user and the charger 520, an instruction 513 is sent to the client 514 to maintain or increase the charging or output power.

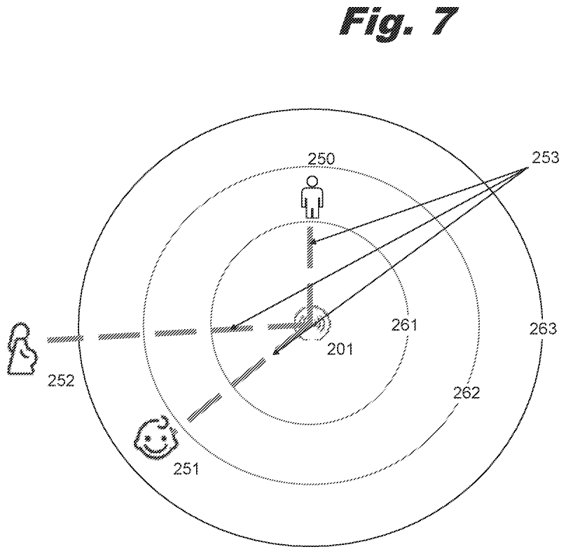

FIG. 7 depicts different output power settings of an illustrative wireless charging system according to the principles described herein. As shown in FIG. 7, the three different example groups discussed above are considered safe at different distance ranges from the wireless charging station 201. Specifically, the average user 250 may be considered safe outside a first distance range 261 from the wireless charging station 201. Children or similar sensitive users 251 are considered safe outside a second, larger distance range 262. Lastly, pregnant women or the most sensitive class of users 252 may be considered safe outside a third, larger range 263.

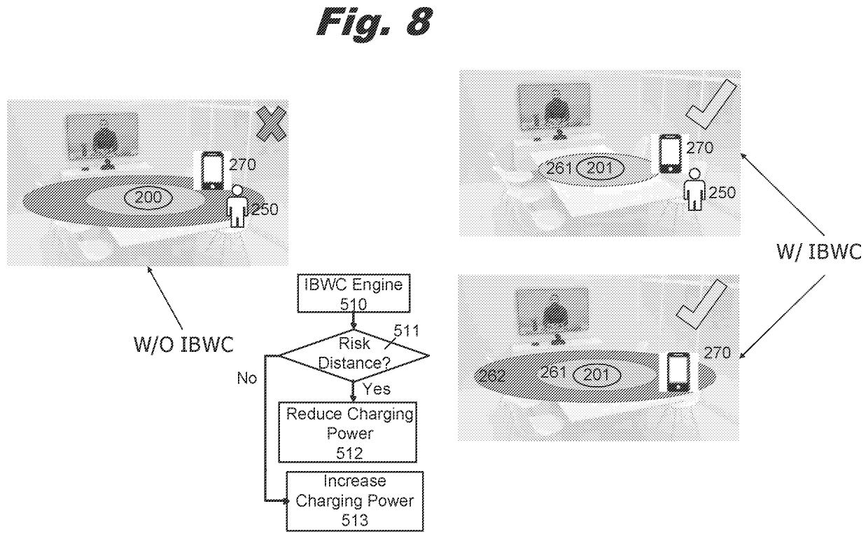

FIG. 8 depicts use of an illustrative wireless charging system in a particular conference room environment according to the principles described herein. In FIG. 8, a user 250 is in a conference room with a mobile phone 270 to be charged by a wireless charging station. On the left side of the figure is illustrated a wireless charging station 200 that does not include the safety features described herein. Consequently, the user 250 is inside an EMF range that is not recommended.

In contrast, on the right side of the figure, a wireless charging station 201 that includes the safety features described herein. Consequently, in the upper panel on the right of the figure, the user 250 has been detected and the power output of the wireless charging station 201 has been reduced. This limits the EMF of the wireless charging station 201 so that levels that are above those recommended are within a smaller distance range 261 that does not encompass the user 250. In the lower panel on the right of the figure, the user 250 has left the room. Consequently, the output power of the wireless charging station 201 has been increased to better charge the phone 270 without risk to the user 250.

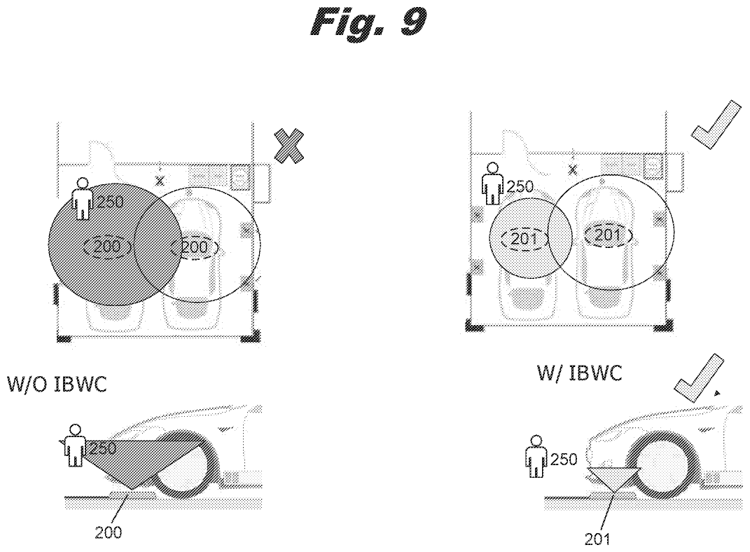

FIG. 9 depicts use of an illustrative wireless charging system in an electric vehicle charging application according to the principles described herein. As shown in FIG. 9, electric vehicles are charged by wireless charging station that is positioned under the battery of the vehicle when parked. On the left of the figure, the wireless charging station 200 does not include the safety features described herein. Consequently, a user 250 may be within a range that is not recommended and no action is taken by the wireless charging station 200. On the right side of the figure, the wireless charging station 201 does include the safety features described herein. Consequently, the distance to a user 250 has been determined to be less than allows operation at the higher output power level shown on the left side. Thus, the output power of the wireless charging station 201 has been reduced so that the user 250 is now outside the EMF range of the wireless charging station 201 in which the user's exposure would not be recommended.

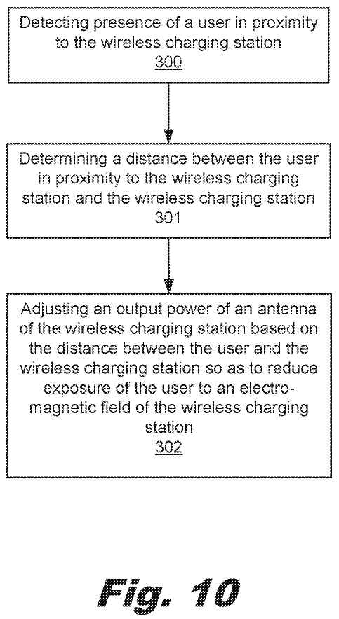

FIG. 10 depicts a flowchart of operation of an illustrative wireless charging system according to the principles described herein. As shown in FIG. 10, the method of operating the wireless charging station includes detecting 300 the presence of a user in proximity to the wireless charging station; determining 301 a distance between the user in proximity to the wireless charging station and the wireless charging station; and adjusting 302 an output power of an antenna of the wireless charging station based on the distance between the user and the wireless charging station so as to reduce exposure of the user to an electro-magnetic field of the wireless charging station.

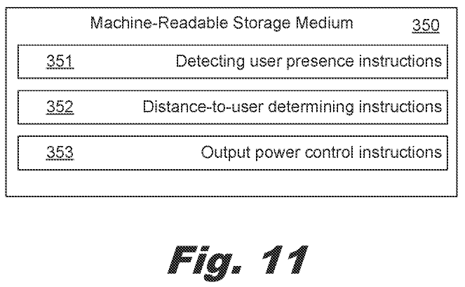

FIG. 11 depicts a non-transitory computer-readable medium with programming for a controller of an illustrative wireless charging system according to the principles described herein. As shown in FIG. 11, a computer program product comprising a non-transitory computer-readable medium storing instructions for a controller of a wireless charging station. The medium can be any device or medium as described herein. The instructions, when implemented by a processor of the controller, cause the controller to: detect 351 a presence of a user in proximity to the wireless charging station; determine 352 a distance between the user in proximity to the wireless charging station and the wireless charging station; and adjust 353 an output power of an antenna of the wireless charging station based on the distance between the user and the wireless charging station so as to reduce exposure of the user to an electro-magnetic field of the wireless charging station.

The preceding descriptions of the various examples have been presented for purposes of illustration, but are not intended to be exhaustive or limited to the principles disclosed. Many modifications and variations will be apparent to those of ordinary skill in the art without departing from the scope and spirit of the described examples.

What is claimed is:

1. A wireless charging station comprising:
a power transmitting antenna;
a controller;
a distance-to-user tool of the controller to determine a distance between a user and the wireless charging station; and
an output power control of the controller to adjust a power output of the power transmitting antenna based on the determined distance between the user and the wireless charging station.

2. The wireless charging station of claim 1, further comprising a distance detector to output data to the distance-to-user tool to determine the distance between the user and the wireless charging station.

3. The wireless charging station of claim 1, further comprising a transceiver or network interface to communicate with a set of Internet of Things (IoT) devices that provide data to the distance-to-user tool to determine the distance between the user and the wireless charging station.

4. The wireless charging station of claim 1, wherein the output power control adjusts the power output of the power transmitting antenna based on a type of the user determined to be within a risk distance of the wireless charging station.

5. The wireless charging station of claim 4, wherein children have a different risk distance than an average user.

6. The wireless charging station of claim 5, wherein pregnant women have a different risk distance than an average user or children.

7. The wireless charging station of claim 1, further comprising a server in communication with the controller via a network interface, wherein the distance-to-user tool is to communicate with an information collector and engine of the server to determine the distance between the user and the wireless charging station, the output power control to receive instructions from the server for adjusting the power output of the power transmitting antenna.

8. The wireless charging station of claim 7, wherein the server comprises a risk distance repository listing recommended safe distances for different users and associated power output levels.

9. The wireless charging station of claim 8, wherein the server comprises user profiles for the different users.

10. The wireless charging station of claim 7, wherein the instructions from the server include an instruction to increase the power output of the power transmitting antenna.

11. A method of operating a wireless charging station, the method comprising:
detecting presence of a user in proximity to the wireless charging station;
determining a distance between the user in proximity to the wireless charging station and the wireless charging station; and
adjusting an output power of an antenna of the wireless charging station based on the distance between the user and the wireless charging station so as to reduce exposure of the user to an electro-magnetic field of the wireless charging station.

12. The method of claim 11, further comprising using input from a set of Internet of Things (IoT) devices to detect the presence of the user and determine the distance between the user and the wireless charging station.

13. The method of claim 11, further comprising using a distance detector to determine the distance between the user and the wireless charging station.

14. The method of claim 11, further comprising adjusting the power output of the antenna based on a type of the user determined to be within a risk distance of the wireless charging station, wherein different types of users have different risk distances.

15. The method of claim 14, further comprising communicating with a server via a network interface for user profiles and associated risk distances.

16. A computer program product comprising a non-transitory computer-readable medium storing instructions for a controller of a wireless charging station, the instructions, when implemented by a processor of the controller, cause the controller to:
detect a presence of a user in proximity to the wireless charging station;
determine a distance between the user in proximity to the wireless charging station and the wireless charging station; and
adjust an output power of an antenna of the wireless charging station based on the distance between the user and the wireless charging station so as to reduce exposure of the user to an electro-magnetic field of the wireless charging station.

17. The product of claim 16, further comprising instructions for receiving input from a set of Internet of Things (IoT) devices to detect the presence of the user and determine the distance between the user and the wireless charging station.

18. The product of claim 16, further comprising instructions for using input from a distance detector to determine the distance between the user and the wireless charging station.

19. The product of claim 16, further comprising instructions for adjusting the power output of the antenna based on a type of the user determined to be within a risk distance of the wireless charging station, wherein different types of users have different risk distances.

20. The product of claim 19, further comprising instructions for communicating with a server via a network interface for user profiles and associated risk distances.
